(19) United States
(12) Patent Application Publication
(10) Pub. No.: US 2014/0195697 A1
(43) Pub. Date: Jul. 10, 2014

(54) APPARATUS AND METHOD FOR DETECTING FUNCTIONS OF VIDEO CARD

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventor: CHUN-SHENG CHEN, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/147,563

(22) Filed: Jan. 5, 2014

(30) Foreign Application Priority Data
Jan. 10, 2013 (CN) 2013100084337

(51) Int. Cl. G06F 13/38

(52) U.S. Cl. CPC G06F 13/385
USPC 710/10

(57) ABSTRACT

A video card detection device electrically connects to a motherboard of a computing device to detect functions of an integrated video card and an independent video card of the motherboard. The independent video card is configured to electrically connect to a first display, and the integrated video card is configured to electrically connect to a second display. Functions of the independent video card are detected first. When the functions of the independent video card have been detected, functions of the independent video card are disabled. Then, the computing device is restarted to detect functions of the integrated video card.

### BACKGROUND

1. Technical Field

Embodiments of the present disclosure relate to an apparatus and method for detecting functions of video cards of computer systems.

2. Description of Related Art

Detection of functions of video cards of computer systems is an important process in the manufacture of the computer systems. The computer system may include an integrated video card arranged on a motherboard, and an independent video card connected to the motherboard via a peripheral component interconnect express (PCIE) slot. Functions of both the integrated video card and the independent video card must be detected. The functions of the independent video card are usually detected first. After the detection of the functions of the independent video card, the computer system is powered off to disconnect the independent video card from the motherboard. The computer system is then restarted to detect functions of the integrated video card. Thus, the process of detecting the functions of both the independent video card and the integrated video card is inconvenient and time-consuming. Therefore, there is room for improvement in the art.

### BRIEF DESCRIPTION OF THE DRAWINGS

FIG. 1 shows a schematic diagram of a video card detection device connected to a motherboard.

FIG. 2 is a schematic block diagram of the video card detection device of FIG. 1.

FIG. 3 is a circuit diagram of a detection circuit of FIG. 2.

FIG. 4 is a flowchart of one embodiment of a method for detecting functions of an integrated video card and of an independent video card of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

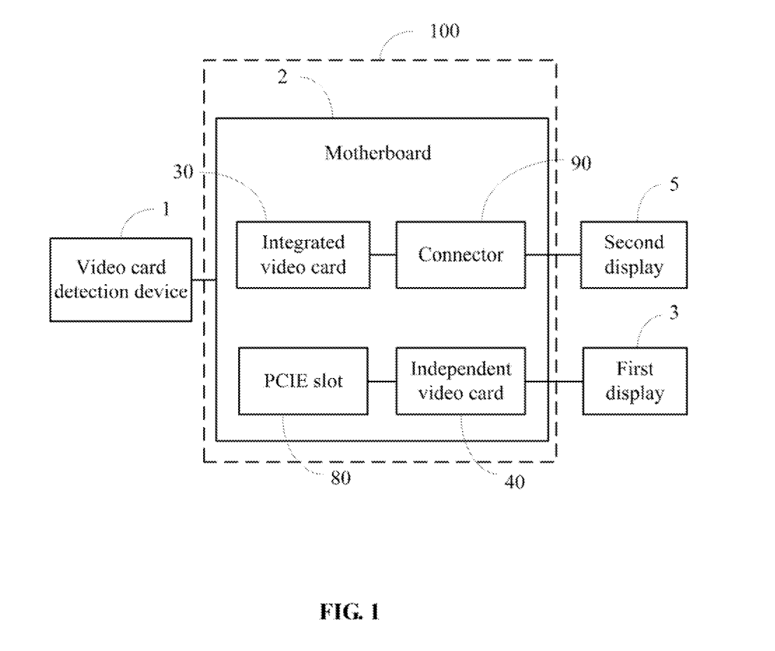

FIG. 1 shows a schematic diagram of a video card detection device 1 connected to a motherboard 2 of a computer system 100. The motherboard 2 includes an integrated video card 30, a connector 90, a peripheral component interconnect express (PCIE) slot 80, and an independent video card 40. The independent video card 40 is plugged into the PCIE slot 80 to electrically connect to the motherboard 2. The independent video card 40 is configured to connect a first display 3 to the motherboard 2. The integrated video card 30 is configured to connect a second display 5 to the motherboard 2 via the connector 90. In this embodiment, the connector 90 is a video graphics array (VGA) connector. The first display 5 can connect to the independent video card 40 via another VGA connector (not shown) of the motherboard 2. The video card detection device 1 is configured to detect functions of both the integrated video card 30 and the independent video card 40.

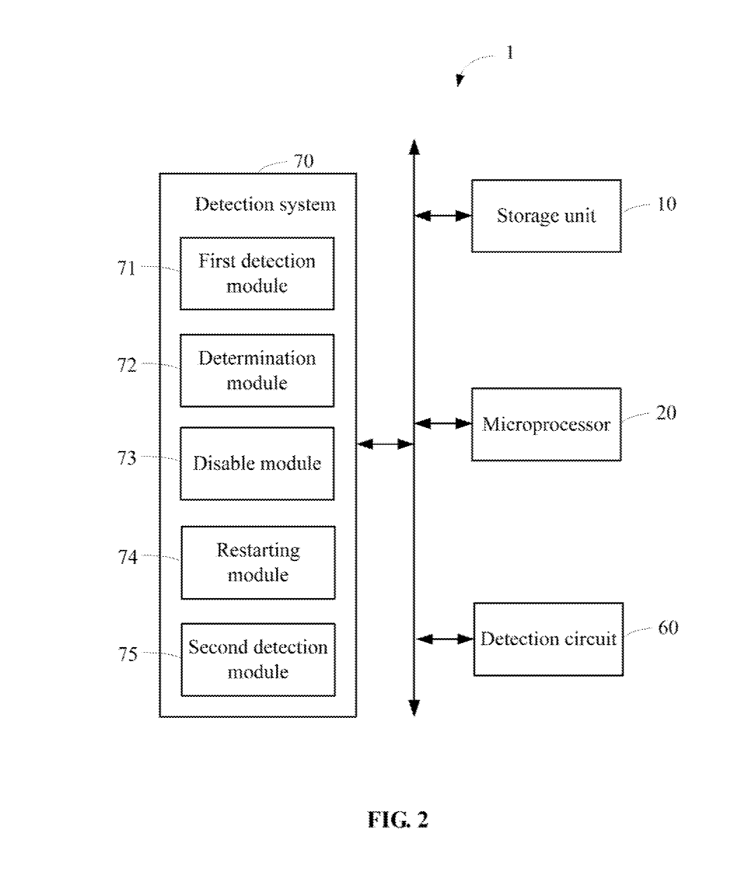

FIG. 2 is a schematic block diagram of the video card detection device 1 of

FIG. 1. In one embodiment, the video card detection device 1 includes a storage unit 10, a microprocessor 20, a detection circuit 60, and a detection system 70. The detection system 70 includes a first detection module 71, a determination module 72, a disable module 73, a restarting module 74, and a second detection module 75. The modules 71-75 include computerized codes in the form of one or more programs that are stored in the storage unit 10. The computerized codes include computer-readable program codes (instructions) that are executed by the microprocessor 20 to provide functions for the video card detection device 1.

The storage unit 10 may be a cache or a dedicated memory, such as an erasable programmable read only memory (EPROM), a hard disk drive (HDD), or a flash memory. In general, the word “module,” as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The first detection module 71 sends a first command to the computing device 100 via the motherboard 2. The first command triggers the computing device 100 to execute a predetermined video card detection program to detect functions of the independent video card 40. Whether the functions of the independent video card are normal or not can be manually determined according to information displayed on the first display 3.

The determination module 72 determines whether the integrated video card 30 is electrically connected to the second display 5 when the functions of the independent video card 40 have been detected. In this embodiment, the determination module 72 determines whether the integrated video card 30 is electrically connected to the second display 5 by using the detection circuit 60.

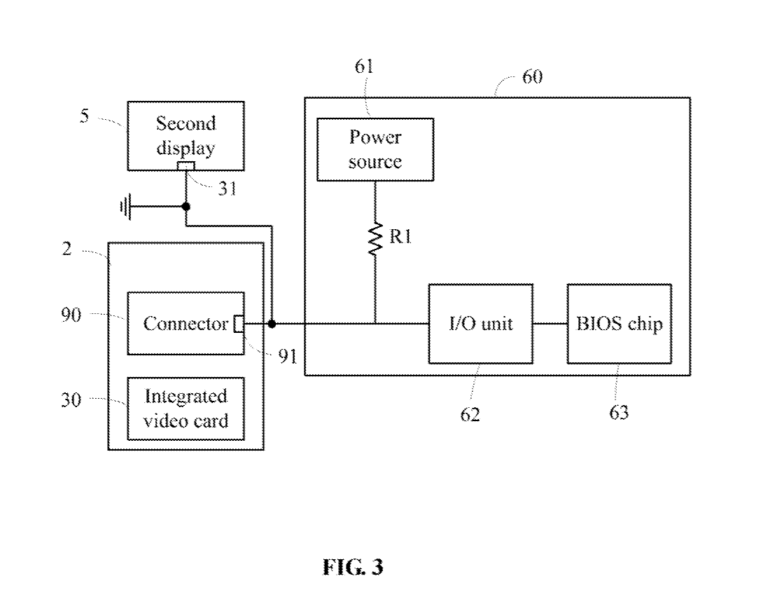

Referring to FIG. 3, a circuit diagram of the detection circuit 60 is shown. The detection circuit 60 includes a power source 61, a resistor R1, an input/output (I/O) unit 62, and a basic input/output system (BIOS) chip 63. The I/O unit 62 is electrically connected between the connector 90 and the BIOS chip 63. The connector 90 includes a first detection pin 91. The second display 5 includes a second detection pin 31, which is grounded. The first detection pin 91 is electrically connected to the I/O unit 62. The I/O unit 62 is further electrically connected to the power source 61 via the resistor R1. When the second display 5 is electrically connected to the connector 90, the first detection pin 91 is electrically connected to the second detection pin 51. The I/O unit 62 outputs a first voltage signal (e.g., a low-level voltage signal of 0 volts (V)) to the BIOS chip 63. The BIOS chip 63 outputs a first detection signal (e.g., digital “0”) to the determination module 72 according to the first voltage signal. When the second display 5 is not electrically connected to the connector 90, the first detection pin 91 is not connected to the second detection pin 51. At this time, a voltage output from the power source 61 is applied to the I/O unit 62. Thus, the I/O unit 62 outputs a second voltage signal (e.g., a high-level voltage signal of 3.3V) to the BIOS chip 63. The BIOS chip 63 outputs a second detection signal (e.g., digital “1”) to the determination module 72 according to the second voltage signal. Therefore, the determination module 72 can determine whether the integrated video card 30 is electrically connected to the second display 5 according to the first detection signal and the second detection signal. In this embodiment, the resistor R1 is a pull-up resistor, and the I/O unit 62 is a super I/O chip of the computing device 100.

The disable module 73 disables functions of the independent video card 40 when the integrated video card 30 is electrically connected to the second display 5, so as to detect the functions of the integrated video card 30. In this embodiment, the disable module 43 disables the functions of the independent video card 40 by electrically disconnecting the independent video card 40 and the first display 3 from the motherboard 2.

The restarting module 74 restarts the computing device 100 when the functions of the independent video card 40 are disabled. The second detection module 75 sends a second command to the computing device 100 via the motherboard 2 when the computing device 100 has been restarted. The second command triggers the computing device 100 to execute the predetermined video card detection program to detect functions of the integrated video card 30. Whether the functions of the integrated video card 30 are normal or not can be manually determined according to information displayed on the second display 5.

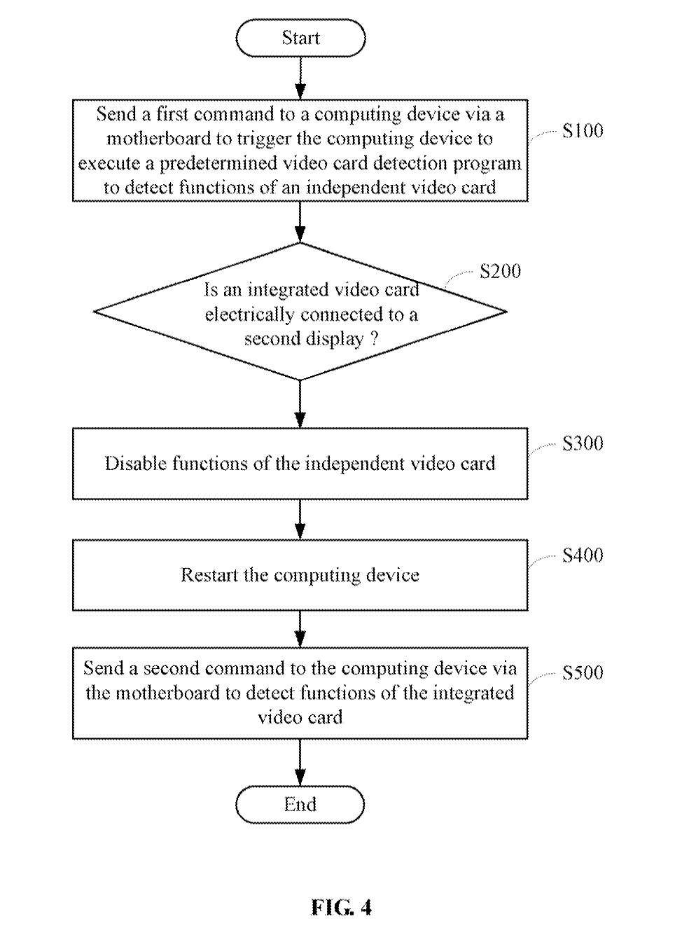

FIG. 4 is a flowchart of a method for detecting functions of the integrated video card 30 and the independent video card 40 of FIG. 1 using the functional modules of the video card detection device 1. Depending on the embodiment, additional steps may be added, others removed, and the ordering of the steps may be changed.

In step S100, the first detection module 71 sends a first command to the computing device 100 via the motherboard 2 to trigger the computing device 100 to execute a predetermined video card detection program to detect functions of the independent video card 40.

In step S200, the determination module 72 determines whether the integrated video card 30 is electrically connected to the second display 5 when the functions of the independent video card have been detected. If the integrated video card 30 is not electrically connected to the second display 5, step S300 is implemented. Otherwise, the procedure ends.

In step S300, the disable module 73 disables functions of the independent video card 40.

In step S400, the restarting module 74 restarts the computing device 100.

In step S500, the second detection module 75 sends a second command to the computing device 100 via the motherboard 2 when the computing device 100 has been restarted, to trigger the computing device 100 to execute the predetermined video card detection program to detect functions of the integrated video card 30.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A video card detection device connected to a motherboard of a computing device, the motherboard comprising an independent video card configured to connect to a first display and an integrated video card configured to connect to a second display, the video card detection device comprising:
a first detection module sending a first command to the computing device via the motherboard, the first command triggering the computing device to execute a predetermined video card detection program to detect functions of the independent video card;
a determination module determining whether the integrated video card is electrically connected to the second display when the functions of the independent video card have been detected;
a disable module disabling functions of the independent video card when the integrated video card is electrically connected to the second display;
a restarting module restarting the computing device; and
a second detection module sending a second command to the computing device via the motherboard when the computing device has been restarted, the second command triggering the computing device to execute the predetermined video card detection program to detect functions of the integrated video card.

2. The video card detection device according to claim 1, wherein the motherboard further comprises a connector and a peripheral component interconnect express (PCIE) slot, the integrated video card is connected to the second display via the connector, and the independent video card is plugged into the PCIE slot.

3. The video card detection device according to claim 2, wherein the connector is a video graphics array (VGA) connector.

4. The video card detection device according to claim 2, wherein the video card detection device further comprises a detection circuit connected to the connector of the motherboard; when the second display is electrically connected to the integrated video card via the connector, the detection circuit outputs a first detection signal; when the second display is not electrically connected to the integrated video card via the connector, the detection circuit outputs a second detection signal.

5. The video card detection device according to claim 4, wherein the determination module determines whether the integrated video card is electrically connected to the second display according to the first detection signal and the second detection signal.

6. The video card detection device according to claim 4, wherein the detection circuit comprises a power source, a resistor, an input/output (I/O) unit, and a basic input/output system (BIOS) chip, the I/O unit is connected between the connector and the BIOS chip, the connector has a first detection pin, the second display has a second detection pin which is grounded, the first detection pin is connected to the I/O unit, and the I/O unit is further connected to the power source via the resistor.

7. The video card detection device according to claim 6, wherein when the second display is electrically connected to the connector, the first detection pin is connected to the second detection pin, the I/O unit outputs a first voltage signal to the BIOS chip, and the BIOS chip outputs the first detection signal according to the first voltage signal; when the second display is not electrically connected to the connector, the first detection pin is not connected to the second detection pin, a voltage output from the power source is applied to the I/O unit, the I/O unit outputs a second voltage signal to the BIOS chip, and the BIOS chip outputs a second detection signal according to the second voltage signal.

8. The video card detection device according to claim 6, wherein the I/O unit is a super I/O chip of the computing device.

9. The video card detection device according to claim 6, wherein the resistor is a pull up resistor.

10. The video card detection device according to claim 7, wherein the first voltage signal is a low level voltage signal and the second voltage signal is a high level voltage signal.

11. A method for detecting function of video cards of a computing device using a video card detection device, the video card detection device connected to a motherboard of the computing device, the motherboard comprising an independent video card configured to connect to a first display and an integrated video card configured to connect to a second display, the method comprising:
sending a first command to the computing device via the motherboard, the first command triggering the computing device to execute a predetermined video card detection program to detect functions of the independent video card;
determining whether the integrated video card is electrically connected to the second display when the functions of the independent video card have been detected;
disabling functions of the independent video card when the integrated video card is electrically connected to the second display;
restarting the computing device; and
sending a second command to the computing device via the motherboard when the computing device has been restarted, the second command triggering the computing device to execute the predetermined video card detection program to detect functions of the integrated video card.

12. The method according to claim 11, wherein the motherboard further comprises a connector and a peripheral component interconnect express (PCIE) slot, the integrated video card is connected to the second display via the connector, and the independent video card is plugged into the PCIE slot.

13. The method according to claim 12, wherein the connector is a video graphics array (VGA) connector.

14. The method according to claim 12, wherein the video card detection device comprises a detection circuit connected to the connector of the motherboard; when the second display is electrically connected to the integrated video card via the connector, the detection circuit outputs a first detection signal; when the second display is not electrically connected to the integrated video card via the connector, the detection circuit outputs a second detection signal.

15. The method according to claim 14, wherein whether or not the integrated video card is electrically connected to the second display is determined according to the first detection signal and the second detection signal.

16. The method according to claim 14, wherein the detection circuit comprises a power source, a resistor, an input/output (I/O) unit, and a basic input/output system (BIOS) chip, the I/O unit is connected between the connector and the BIOS chip, the connector has a first detection pin, the second display has a second detection pin which is grounded, the first detection pin is connected to the I/O unit, and the I/O unit is further connected to the power source via the resistor.

17. The method according to claim 16, wherein when the second display is electrically connected to the connector, the first detection pin is connected to the second detection pin, the I/O unit outputs a first voltage signal to the BIOS chip, and the BIOS chip outputs the first detection signal according to the first voltage signal; when the second display is not electrically connected to the connector, the first detection pin is not connected to the second detection pin, a voltage output from the power source is applied to the I/O unit, the I/O unit outputs a second voltage signal to the BIOS chip, and the BIOS chip outputs a second detection signal according to the second voltage signal.

18. The method according to claim 16, wherein the I/O unit is a super I/O chip of the computing device.

19. The method according to claim 16, wherein the resistor is a pull up resistor.

20. The method according to claim 17, wherein the first voltage signal is a low level voltage signal and the second voltage signal is a high level voltage signal.
